(19) United States
(12) Patent Application Publication
(10) Pub. No.: US 2017/0061383 A1
(43) Pub. Date: Mar. 2, 2017

(54) HUMAN RESOURCE MANAGEMENT METHOD

(71) Applicant: Hiroaki MIYAUCHI, Singapore (SG)

(72) Inventor: Hiroaki MIYAUCHI, Singapore (SG)

(21) Appl. No.: 15/248,607

(22) Filed: Aug. 26, 2016

(30) Foreign Application Priority Data
Aug. 28, 2015 (SG) 10201506815S

(51) Int. Cl. G06Q 10/10

(52) U.S. Cl. CPC G06Q 10/1057

(57) ABSTRACT

A computer-implemented method of human resource management for completing succession process includes (i) deciding, using a computing apparatus to check, if an employee meet criteria of becoming a member of a reward alumni club; (ii) registering the employee as a member with the reward alumni club if the criteria are met; (iii) accumulating membership reward of the member; (iv) checking if the member leaves the reward alumni club; (v) examining, after departure of the member, if succession process of the member has been duly completed; (vi) summarising the membership reward after completion of the succession process; and (vii) disbursing the membership reward to the member.

The present application claims an earlier priority date of Singapore patent application Number 10201506815S that was filed on 28 Aug. 2015. Content or subject matter of the earlier priority application is hereby incorporated entirely by reference.

### FIELD OF INVENTION

The present application relates to a human resource management method. The method is alternatively known as an Employee Engagement Model (AEM). The application also relates to a computer implemented method of human resource management scheme or Employee Engagement Model (AEM).

### BACKGROUND

In job market, it is common that an employee seeks career advancement either by being promoted to a better position within the company or by joining a new employer when receiving better offer. It is also common that an employer forms various organizations or policies either by choosing talented people internally or hiring capable candidates from external. Many employers implement some talent retention schemes to promote employees' loyalties to prolong length of one's service with the employers and minimise probability of business-disrupting job-hops. The present application does not focus on the traditional “retention” which employers' efforts should be continued. Instead, the present application provides an “Alumni Engagement Model (AEM)”, which focuses on elimination of such practical human resource-related risks like the following risks (hereafter as Practical Human Resource Risks) to the original employer, which include:
(i) interruption of, or degradation to quality of business operation caused by improper job handover by the leaving employee;
(ii) leaving employee working for competitors and/or misuse of trade secrets or confidential information by the leaving employee;
(iii) blemish to reputation and damage of trust between the original employer and its stakeholders, including customers, suppliers and other employees by the leaving employee.
(iv) Damage of, or degradation to quality of business operation caused by finding of fraud or gross mistake committed by the leaving employee during his past service.

Human Resource management flow in general consists of “entry” management, “retention” management, and “exit” management. There are various known foundations and frame works available to enlighten on entry and retention managements such as employer/employee engagement. However, there is no comprehensive frame work to provide foundation to “exit” management. The present Alumni Engagement Model brings new and useful solution to the problem.

### SUMMARY OF THE INVENTION

The present application aims to provide a new and useful human resource management method so that Practical Human Resource Risks may be reduced or eliminated during and after an employee resigns or is dismissed. The application further aims to propose a computer implemented method of human resource management model. The method or model is alternatively known as technique, approach, arrangement, mechanism, program, system, process, solution, or other words of similar meanings. For example, the human resource management model may be known as an Alumni Engagement Model, whilst employee who have joined the Alumni Club Scheme are known as alumni club members or simply members. Essential features of relevant inventions are provided by one or more independent claims. Important or advantageous features are provided by their dependent claims respectively.

According to a first aspect, the present application provides a computer-implemented method of human resource management for completing succession process. The method comprises a first step of regularly, periodically or continuously deciding, using a computing apparatus (e.g. a Personal Computer, a tablet computer or a mobile electronic device) to check, if an employee meet one or more criteria of being eligible for a membership of a reward alumni club. The employee receives regular remuneration from his employer in exchange of his service rendered to the employer, or a third party via the employer. For example, the employee receives daily, weekly, monthly or yearly salary from the employer. The method further includes a second step of pre-registering the employee for a membership of the reward alumni club if the criteria are met. The criteria are used to examine if the employee qualifies to be eligible for a membership. The alumni club is a collective term that describe a group of employees, qualified to be members. For example, the criteria require an employee to be taking up certain duty or position or employed for certain period of time in order to meet the criteria. The criteria of becoming members may be reviewed, modified and published by the employer.

The method of human resource management additionally comprises a third step of retaining the employee while accumulating membership reward of the alumni club. The membership reward contains monetary reward, corporate benefit reward (e.g. free accommodation), or any other non-monetary reward (e.g. medal of long-service). Particularly, the monetary reward includes money-equivalence reward, such as stock, bond or life insurance policy of the member whose premium paid the employer. Type of the reward and its magnitude are decided usually by multiple factors such as (i) if the amount and mode of reward is influential enough to incentivize employees to refrain from committing Practical Human Resource Risks, and (ii) if it is a reasonable amount of cost justifiable to bear for the employer in terms of its financial performance. The reward can be financially accrued monthly, quarterly or yearly (hereafter “Accrual Basis”) or can be financially posted as and when it is paid out (hereafter “Cash Basis”). The monetary reward may be managed internally by the employer, or externally by a third party entrusted by the employer (e.g. bank or investment fund manager). In one example, the membership reward includes annual banquet offered by the employer.

The method moreover comprises a fourth step of confirming the membership of the reward alumni club when the employee resigns or is dismissed. In either cases, the pre-registered member of the reward alumni club, upon confirmation of resignation from or dismissal by the employer, shall become a confirmed member of the reward alumni club (hereafter “confirmed alumni”). The fourth step also includes calculation of his reward based upon the defined parameters. However, whether the reward is entitled or not shall yet to be determined by the employer. The fourth step further includes for the employer to search a successor and to assign a successor to the confirmed alumni to replace his duty and position with the employer.

The method of human resource management also comprises a fifth step of pre-exit examination of job handover process between the confirmed alumni and the successor. The job handover process is to be carried out in accordance with pre-defined criteria of Pay or No Pay of the reward. Defined criteria may include, among many, two factors: One is quantitative criterion and another is qualitative criterion. Quantitative criterion is such criterion as number of days/weeks necessary to spend with the successor for job handover (hereafter “Required Handover Period”). For example, a junior staff is given a shorter period of Required Handover Period such as one or a few weeks, whilst a senior manager is given a longer Required Handover Period such as one to several months. The hand over period starts from nomination of successor by the company. It is not started from the date of his/her letter of resignation. Qualitative criterion reflects quality of job handover. Among many, three examples of the qualitative criterion are; (i) The job handover process may require a confirmed alumni to take an internal audit prior to leaving, (ii) The job handover may require employees to record Business Process Summary which describe important data, information and knowledge necessary for the successor to take over on the job, and (iii) The job handover may require the successor to appraise satisfaction level of the job handover and sign off the Business Process Summary.

Besides, the method of human resource management comprises a sixth step of post-exit examination and judgement whether pay or not pay the reward to the confirmed alumni. The main objective of Alumni Engagement Model is to reduce or eliminate Practical Human Resource Risks, thus the reward is not paid if any of Practical Human Resource Risks is detected. Among others, the four main risks to be judged are: (i) if an employee's or member's job handover is satisfactory and has not caused disruption or degradation to business operation, (ii) if the departing employee is not working for competitor in his subsequent job, and/or misusing trade secrets or confidential information of his present employer improperly, (iii) if he has not damaged reputation or trust with the employer and its stakeholders, and (iv) if he has not committed fraud or gross negligence in the job during his employment. If the payment of the reward is defined to be one lump sum, the decision is made once. If the payment of the reward is by multiple installments over several years, the first year payment is judged during the first year of departure. The second year payment is decided in the second year, and so on. If any of risks are detected, following years' payments are stopped.

During retention or after resignation or dismissal of the employee, before completion of the reward payments or even after completion of the reward payments, the method further comprises a seventh step of ongoing effort to promote an alumni engagement culture with both employees and alumni. The promotion may be enhanced by various initiatives such as a periodical issuance of an alumni bulletin and arrangements of seminars, meetings, parties and special events.

Some of these steps of the method may be divided, combined, modified or changed in sequence. For example, the employer may, by using the computing apparatus, firstly summarising the membership reward after completion of the succession process, followed by the step of examining, after departure of the member, if succession process of the member has been duly completed.

The method can further comprise a step of checking if the member changes his or her reward grade with the reward alumni club. Since employees of the employer can have diverse job scope, responsibilities and roles, successful successions of these employees have dissimilar impact to the employer. For example, it is usually more crucial to complete the succession process well with a Sales Manager than an office cleaner, although both roles require proper job succession. In view of relevant importance, the employer can assign several grades to multiple roles respectively such that the membership reward is tailored or adapted to responsibilities of job roles. If a member progresses and changes within the employer, the grades change according to these job roles accordingly. The membership reward is thus accumulated during the course of changing roles. Therefore, the method is flexible and adaptable according to different job roles within the employer.

The method may further comprise a step of limiting the membership reward to a predetermined limit of the member, known as the maximum membership reward. For example, the predetermined limit is calculated by multiplying the last month salary of a departing member by ten (10) times. Hence, regardless job roles or duration of membership, a departing member will receive a fixed sum if he has accumulated the maximum amount of membership reward. This step effectively discourages a member or employee to stay with the employer over an excessively time period of employment. This step also limits financial liability of the employer.

The method can further comprise a step of inviting an employee to join the reward alumni club. Since the membership is voluntary, an employee is free to join the reward alumni club if offered by the employer. In other words, some employees of the employer are not offered invitation to join the reward alumni club for various reasons. For example, the employer only invite employees who has worked full-time of minimum three (03) years to be a member. Additionally, the employer does not invite operators of production lines to be members of the reward alumni club. On the other hand, any member is free to leave the reward alumni club at any time, whether as remains as an employee or not.

The step of accumulating membership reward may include a first step of calculating days of being the member with the reward alumni club; and a second step of counting the total number of days over a ten-year period starting from the date becoming the member. In practice, some years may have 365 days per year, whilst other years may have 366 days per year. These two steps may be performed by the computing apparatus to calculate actual number of days of the membership, and the total number of days over the ten (10) year period starting from the first of being the member. The step of accumulating membership reward may additionally include a third step of deciding a ratio of the days of being the member over the total number of days over the ten-year period. The third step presents a ratio of membership days over a ten-year period of membership. The step of accumulating membership reward may moreover include a fourth step of accumulating ten times of the latest salary of the member when leaving the employer as the maximum membership reward. The ten times of the latest salary of the member may be replaced by the maximum amount of membership reward or the predetermined limit of the membership reward. For example, the employer may fix a limit of USD$1,000,000 as the maximum amount of membership reward for a senior member. The employer may further provide another limit of USD$500,000 as the maximum amount of membership reward for a junior member. The step of accumulating membership reward may in addition include a subsequent fifth step of multiplying the ratio and the maximum membership reward as a final membership reward. Hence, the membership reward is prorated according to actual days of being a member of the reward alumni club and over the predetermined amount of membership reward. The predetermined amount of membership reward includes the maximum membership reward.

Alternatively, the step of accumulating membership reward can include an initial step of numbering years of being the member with the reward alumni club; and a secondary step of getting a year ratio of the number of years being the member over a ten-year period. The step of accumulating membership reward can further comprise a third step of figuring days of the last year of being the member with the reward alumni club; and a fourth step of obtaining a day ratio of the number of days being the member during the last year. The step of accumulating membership reward can additionally comprise a fifth step of aggregating ten (10) times of the latest salary of the member when leaving the employer as the maximum membership reward; and a sixth step of recording a year membership reward by multiplying the year ratio with the maximum membership reward. The step of accumulating membership reward can also provide a seventh step of noting a day membership reward by multiplying the day ratio with a last month salary; and an eighth step of adding the year membership reward and the day membership reward together as a final membership reward. The present step of accumulating membership reward effectively offers an alternative approach to prorate actual time period of being a member in order to receive the membership reward proportionally. The two (02) prorated approaches offer objective and fair technique to compute the membership reward, which are easily implemented by one or more of the computing apparatus.

The method may further comprise a step of checking one or more electronic addresses of an electronic device of the employee, the member, or both. Since a single electronic device may have one or more unique electronic addresses, the one or more unique electronic addresses may be conveniently used as electronic identities to exclusively locate the electronic device, thereby confirming an identify of the employee, the member or both. In view of increasing popularity of mobile electronic devices (e.g. mobile phones) and fast-advancing capabilities of the mobile electronic devices, every employee or member usually has one or more personal mobile electronic devices, such as mobile phones, tablet computers and notebook computers. These mobile electronic devices may be utilized to uniquely identify the employee or member for communication and transaction, providing convenience, confidentiality, clarity and swiftness of handling the membership reward automatically. The employer may deploy one or more computing servers that exchange information or transact with members' electronic devices automatically, before or after confirming authenticity of the members via the one or more electronic addresses of their electronic devices. For example, transaction of the membership reward may be authenticated by acquiring and verifying finger prints of the members. The method may additionally comprise a step of checking one or more biometric identifiers of the member, which provides distinctive, measurable characteristics used to label and describe the members, the employees or both the members and the employees. Sensors or readers (e.g. camera, scanner) may be connected installed onto the electronic device in order to collect the biometric identifiers.

The method can further comprise a step of updating the one or more electronic addresses of the electronic device of the employee, the member, or both. Since the member or employee can change, upgrade or add one or more electronic devices, the electronic addresses can be updated by the employer in order to facilitate electronic communication and transaction.

The method may further comprise a step of adopting relevant latest salary of the member for accumulating the maximum membership reward. For example, a member's relevant last salary as an engineer is used to calculate the maximum membership reward as the engineer. If promoted as a manager, the member's relevant last salary becomes the manager's latest salary. In other words, the maximum membership reward may comprise several components, each having different latest salaries. The method accordingly reflects change of job roles and membership durations of these respective job roles.

The method can further comprise a step of modifying the maximum membership reward or alumni membership reward by an importance factor of job handover such that the employer can adjust the maximum membership reward or alumni membership reward. The employer therefore has another option to ensure important job roles are taken care of, whereby good job handover protects the employer's interest.

According to a second aspect, the present application provides a computing system or device for operating the human resource management method. The computing system or device includes one or more computers, computing servers or simply servers. The system comprises a processor, microprocessor or controller operable (i.e. configured to) to decide if an employee meet one or more criteria of becoming a member of a reward alumni club (i.e. alumni club or club). The processor is further configured to perform a step of registering the employee as a member with the reward alumni club if the criteria are met; and another step of accumulating membership reward of the member. The processor is further operable to check if the member leaves the reward alumni club. For example, the member changes from full-time employment to part-time employment such that he is no longer eligible to qualify; and to examine, after departure of the member, if succession process of the member has been duly completed. The processor is further configured to summarize the membership reward after completion of the succession process; and disburse the membership reward to the member. One or more of the above-mentioned steps are automatically executed by the processor according to predetermined instructions, logic, algorithm or computer program (including apps for mobile devices). The processor provides swift, accurate, secure and reliable implementation of these steps so that both the employer and the member are relieved from cumbersome, meticulous and tedious operations. For example, the member is not required to travel back to the office of his previous employer or alumni club after resignation. Communication and transaction relating the membership reward is handled seamlessly.

The processor can be further configured to check if the member changes his reward grade with the reward alumni club. Since the member sometimes change his role within the employer, these different roles are associated to various grades of the reward alumni club in order calculate appropriate amount of monetary reward.

The processor may be further configured to limit the membership reward to a predetermined limit (e.g. be less than ten times salary of his last month) of the member, known as the maximum membership reward. Other limits or maximum membership reward may be tabulated or decided by the employer, the member or both via negotiation. Thus, the employer provides a conducive employment environment that is attractive to the member, employee or both.

The processor can be further configured to invite an employee to join the reward alumni club. This step allows the employer to take initiative and also keep options open to employees. Typically, the invitation will encourage the employee to stay or be loyal to the employer.

The processor may be configured to accumulate the membership reward by taking a first step of calculating days of being the member with the reward alumni club; a second step of counting the total number of days over a ten-year period starting from the date becoming the member; a third step of deciding a ratio of the days of being the member over the total number of days over the ten-year period; a fourth step of accumulating ten times of the latest salary of the member when leaving the employer as the maximum membership reward; and a fifth step of multiplying the ratio and the maximum membership reward as a final membership reward. Some of these steps of the method may be divided, combined, modified or changed in sequence.

The processor can further be operable to accumulate the membership reward by taking additional steps as follows. Particularly, the processor can be configured to take a first step of numbering years of being the member with the reward alumni club; a second step of getting a year ratio of the number of years being the member over a ten-year period; a third step of figuring days of the last year of being the member with the reward alumni club; a fourth step of obtaining a day ratio of the number of days being the member during the last year; a fifth step of aggregating ten times of the latest salary of the member when leaving the employer as the maximum membership reward; a sixth step of recording a year membership reward by multiplying the year ratio with the maximum membership reward; a seventh step of noting a day membership reward by multiplying the day ratio with a last month salary; and an eighth step of adding the year membership reward and the day membership reward together as a final membership reward. Some of these steps of the method may be divided, combined, modified or changed in sequence.

The processor may be further configured to check one or more electronic addresses of an electronic device of the employee, the member, or both. Since some of the electronic addresses of the electronic device are unique and static, one or more of these electronic addresses are used to identify the electronic device. The employee or member is more conveniently identified via the electronic device, whether accompanied by other verification means. For example, routine notification from the employer to the member is transmitted without multiple verification of electronic addresses, whilst important transaction of the monetary reward is counter-checked by authorised access to multiple electronic addresses. Several electronic devices may be deployed to enhance reliability and security of relevant transaction.

The processor can be further configured to update the one or more electronic addresses of the electronic device of the employee, the member, or both. Change of electronic device by the member or the employee thus no longer hampers the method of human resource management. The method can further comprise a step of adopting relevant latest salary of the member for accumulating the maximum membership reward. Some of these steps of the method may be divided, combined, modified or changed in sequence.

The afore-mentioned system is alternatively known as an apparatus, a device or a widget that further can moreover comprise a computing server of the employer having the processor. The computing server can include one or more non-volatile memories, display screen, user interface devices, peripheral devices (e.g. printer) or any other suitable instruments (e.g. fingerprint scanner). Parts or components of the computing server are connected together for executing the prescribed method steps.

The system may further comprise a remote computing server of a bank, which is configured to communicate with the computing server of the employer via a secure communication protocol (e.g. by using hardware key, Ethernet). The secure communication protocol may include data encryption, stenography, identity based networks, anonymized networks, anonymous communication devices, neutrinos communication or a combination of any of these tools.

The system can further comprise a remote computing server of a bank, which is configured to communicate with the computing server of the employer via the secure communication protocol (hardware key, Ethernet). Hence, the remote computing server of the bank increases confidence of the employer, the member or both in deploying the method of human resource management.

The system may further comprise a distant computing server of an insurance company, which is configured to communicate with the computing server of the employer, the remote computing server of the bank, or both the computing server of the employer and the remote computing server of the bank via the one or more secure communication protocols (hardware key, Ethernet). These multiple parties (e.g. several servers) verify identities of each other so that imposters or intruders are easily exposed and excluded.

The computing server of the employer, the distant computing server of an insurance company, the remote computing server of a bank, or a combination of these computing servers can be configured or operable to communicate with a mobile communication device of the employee, the member or both. The mobile communication device comprises a tablet computer, a mobile phone, or notebook computer. Hence, the employer, the insurance company, the bank or another institution can communicate with the member or employee via the mobile communication device easily, securely, reliably and remotely.

The computing server of the employer, the distant computing server of an insurance company, the remote computing server of a bank, or a combination of these computing servers may be configured or operable to verify electronic identity, which include single or multiple electronic addresses, biometric data, geographical information of the mobile communication device of the employee, the member or both. Since these computers or servers may communicate with each other automatically, data exchange and monetary transaction are made simple and swift.

The computing server of the employer, the distant computing server of an insurance company, the remote computing server of a bank, the mobile communication device of the employee, the member or both or a combination of these can be configured or operable to communicate or verify electronic identity. The electronic identity comprises single or multiple electronic addresses, biometric data, geographical information of these computers, servers or parties, which can include electronic devices (e.g. server, computer) of additional parties, such as merchandisers, credit card companies, transport companies. Communication network of these method can thus be expanded and scalable.

According to a third aspect, the present application provides a non-transient computer readable medium (e.g. hard disk drive, solid state memory, compact disc read only memory, DVD) containing program instructions for causing one or more computers or servers to perform the method of human resource management for completing succession process. The method comprises a first step of regularly or continuously deciding, using a computing apparatus to check, if an employee meet criteria of becoming a member of a reward alumni club; and second step of registering the employee as a member with the reward alumni club if the criteria are met. The method further comprises a third step of accumulating membership reward of the member; and fourth step of checking if the member leaves the reward alumni club. The method moreover comprises a fifth step of examining, after departure of the member, if succession process of the member has been duly completed; and sixth step of summarizing the membership reward after completion of the succession process; and a seventh step of disbursing the membership reward to the member. Some of these steps of the method may be divided, combined, modified or changed in sequence. The non-transient computer readable medium is able to be duplicated, transporter, installed and distributed easily, securely and reliably.

The method may further comprise a step of checking if the member changes his (covering the female term “her”) reward grade with the reward alumni club. The reward grade may be associated different job roles, seniority, geographical regions, or government regulations. For example, in some countries, licensed accountants are important job roles for succession plans of the employer.

The method can further comprise a step of limiting the membership reward to a predetermined limit (e.g. be less than ten times salary of his last month) of the member, known as the maximum membership reward. Alternatively, the predetermined limit can be calculated by a formula, follow inflation rate or reviewed annually. The predetermined limit can reduce financial liability of the employer, or discourage members to extend their employment with employment beyond certain duration.

The method may further comprise a step of inviting an employee to join the reward alumni club. This step makes the membership to be optional, voluntarily, non-compulsory or non-obligational.

The accumulating membership reward can include a first step of calculating days of being the member with the reward alumni club; a second step of counting the total number of days over a ten-year period starting from the date becoming the member; a third step of deciding a ratio of the days of being the member over the total number of days over the ten-year period; a fourth step of accumulating ten times of the latest salary of the member when leaving the employer as the maximum membership reward; a fifth step of multiplying the ratio and the maximum membership reward as a final membership reward. Some of these steps of the method may be divided, combined, modified or changed in sequence. The ten-year period can be modified as any number of years, such as a five-year period, fifteen-year period, twenty-year period, or the total employed-years period.

The accumulating membership reward may include a first step of numbering years of being the member with the reward alumni club; a second step of getting a year ratio of the number of years being the member over a ten-year period; a third step of figuring days of the last year of being the member with the reward alumni club; a fourth step of obtaining a day ratio of the number of days being the member during the last year; a fifth step of aggregating ten times of the latest salary of the member when leaving the employer as the maximum membership reward; a sixth step of recording a year membership reward by multiplying the year ratio with the maximum membership reward; a seventh step of noting a day membership reward by multiplying the day ratio with a last month salary; an eighth step of adding the year membership reward and the day membership reward together as a final membership reward. These steps provide accurate and reliable calculation to the membership reward.

The method may further comprise a step of checking one or more electronic addresses of an electronic device of the employee, the member, or both. The method can further comprise step of updating the at least one electronic address of the electronic device of the employee, the member, or both the employee and the member. The method may further comprise a step of adopting relevant latest salary of the member for accumulating the maximum membership reward. The electronic addresses or identities facilitate automatic identification, which is fast, reliable and confidential, avoiding much hassle to employer and the member.

### BRIEF DESCRIPTION OF THE DRAWINGS

The accompanying figures (Figs.) illustrate embodiments and serve to explain principles of the disclosed embodiments or inventions. It is to be understood, however, that these figures are presented for purposes of illustration only, and not for defining limits of relevant inventions.

FIG. 1 illustrates a human resource management method;

FIG. 2 illustrates implementation of the human resource management method;

FIG. 3 illustrates a process flow of the human resource management method;

FIG. 4 illustrates a pre-process of an AEM chart, which comprises a first stage on eligibility and a second stage on reward type with amount;

FIG. 5 illustrates the pre-process that comprises a third stage of accrual or cash basis by using financial instrument;

FIG. 6 illustrates a post-process of the AEM chart, which comprises a fourth stage of payment method and a fifth stage of pay or no pay criteria;

FIG. 7 illustrates the post-process of the AEM chart, which comprise a sixth stage of promotion of alumni engagement culture;

FIG. 8 illustrates an operation diagram of AEM method having a first stage known as eligibility check phase and a second stage of invitation phase;

FIG. 9 illustrates the operation diagram of the AEM method having a third stage of resignation phase;

FIG. 10 illustrates the operation diagram of the AEM method having a fourth stage of resignation or dismissal phase;

FIG. 11 illustrates the operation diagram of the AEM method having a fifth stage of job handover phase; and

FIG. 12 illustrates the operation diagram of the AEM method having a sixth stage of operation phase and a seventh stage of post-exit phase.

### DETAILED DESCRIPTION

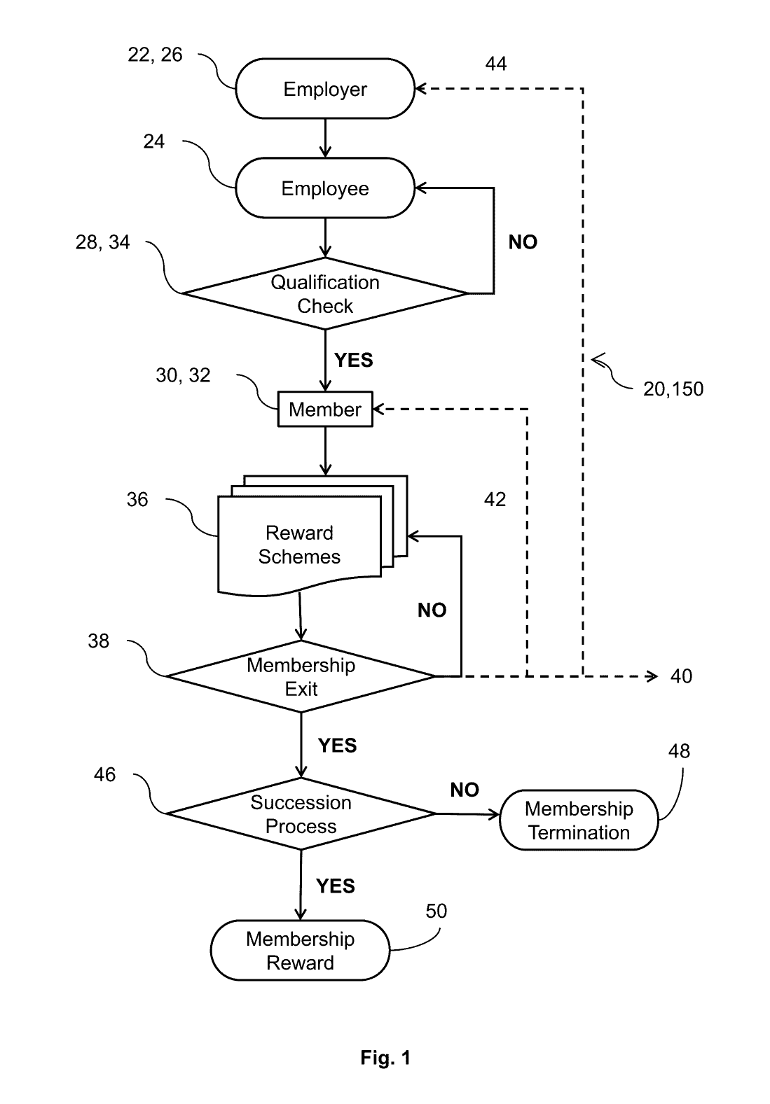

Exemplary, non-limiting embodiments of the present application will now be described with references to the above-mentioned figures. FIGS. 1 & 2 illustrates an embodiment of the relevant invention.

Particularly, FIG. 1 the human resource management method 20 which is implemented by an employer 22 to its employee 24 (also known as a company). The employee 24 works for the employer 22 and receives monthly salary (denoted by symbol “S”) from the employer 22. The employer 22 has the human resource management method 20 in place such that management staffs 26 of the employer 22 executes the human resource management method 20.

The employer 22 has criteria 28 of assessing all its employees 24 on whether the employees 24 are eligible to join an alumni club 30 of the employer 22. Club members or members 32 of the alumni club 30 include employees 24 who have met the criteria 28 and agree to participate with the human resource management method 20. Particularly, the criteria 28 only permit the employees 24 who have worked with the employer 22 on fill-time basis with minimum three (03) years. The criteria 28 prevent employees 24 whose roles do not require specialised knowledge, skill, experience critical to business operation of the employer 22. For example, cleaners and operators of assembly lines are not eligible to join the alumni club 28. The management staffs 26 collectively further have discretion to determine if certain employee 24 may be eligible to be a member 32 of the alumni club 30.

In practice, the management staffs 26 check 34 if an employee 24 has met the criteria 28 of being a member 32 of the alumni club 30. If found eligible, the employer 22 sends an invitation letter and a contract of the human resource management method 20 to the qualified employee 24 who has met the criteria 28. The qualified employee 24 signs the contract after reading and accepting terms and conditions of the contract such that the qualified employee 24 becomes the member 32 of the alumni club 30. Employment condition of the member 32 is continuously verified against the criteria 28 such that the member 32 may be disqualified if not meeting the criteria 28 during his/her employment.

Members 32 of the alumni club 30 are entitled with monetary reward 36 according to the human resource management method 20, which provides a maximum amount of monetary reward equivalent to ten (10) times of the member's last-drawn salary. Particularly, the monetary reward 36 (M) is calculated according to a first equation below.

$$M = ( \frac{365 \times y + d}{365 \times 20} ) \times ( 10 \times s ) \times f$$

In the first equation, alphabetical symbols represent following meaning:
M: Maturity Amount of Club Reward (MCR), which is total amount of membership reward to an exit member;
y: number of years of qualified being the member;
d: number of years within the year of exit as the member;
s: the amount of last-drawn salary as the member;
f: importance factor of job handover.

Alternatively, the Maturity Amount of Club Reward (MCR) may be calculated according to a second equation below.

$$M = ( \frac{A}{T} ) \times ( 10 \times s ) \times f$$

In the second equation, alphabetical symbols represent following meaning:
M: Maturity Amount of Club Reward (MCR), which is total amount of membership reward to an exit member;
A: actual number of days starting from the day of becoming the member to the day of exit;
T: total number of days in 20 years starting from the day of becoming the member;
s: the amount of last-drawn salary as the member;
f: importance factor of job handover.

According to the human resource management method 20, the member 32 continues to accumulate his Maturity Amount of Club Reward (MCR) as long as he remains as an employee 26 and abides terms and conditions of the membership agreement of human resource management method 20. Nevertheless, the maximum amount of Maturity Amount of Club Reward (MCR) is limited to be ten (10) months' last drawn salary of the member 32, which is expressed by a third question below.

$$M = ( 10 \times s ) \times f$$

$$if ( \frac{365 \times y + d}{365 \times 20} ) > 1$$

Alternatively, the maximum amount of Maturity Amount of Club Reward (MCR) may be expressed by a fourth equation below.

$$M = ( 10 \times s ) \times f$$

$$if ( \frac{A}{T} ) > 1$$

During employment, the employee 24 accumulates the Maturity Amount of Club Reward (MCR) during his full-time employment, while qualifying as the member 32. Since the member 32 may be transferred, demoted or promoted to different positions with the employer 22, rate of the accumulates the Maturity Amount of Club Reward (MCR) varies according to these different positions. For example, when appointed as a project leader, the Maturity Amount of Club Reward (MCR) is multiplied by a factor of 1.2 (e.g. “f₁”). If the member is further promoted as a project director who manages several projects of the employer 22, the Maturity Amount of Club Reward (MCR) is multiplied by another factor of 1.6 (e.g. “f₂”). Accordingly, during the entire period of membership with the Reward Club (RC), the member 32 is entitled with the Maturity Amount of Club Reward (MCR) according to following fifth equation,

$$M = P + ( \frac{365 \times y + d}{365 \times 20} ) \times ( 10 \times s ) \times {f}_{1} + ( \frac{365 \times y + d}{365 \times 20} ) \times ( 10 \times s ) \times {f}_{2} + …$$

or a sixth equation below.

$$M = P + ( \frac{A}{T} ) \times ( 10 \times s ) \times {f}_{1} + ( \frac{A}{T} ) \times ( 10 \times s ) \times {f}_{2} + …$$

Nevertheless, the maximum amount of Maturity Amount of Club Reward (MCR) according to the third or fourth equation still apply when having multiple factors (i.e. “fₙ”).

In both the fifth and sixth equations, an additional amount of payment (denoted as “P”) has been included, which comes from an insurance company 52 engaged by the employer 22 on behalf of the member 32. Both the employer 22 and the member 32 contributes monthly to an insurance policy 54 of the insurance company 52 such that the member 32 can receive the full amount after his membership exit 38 and completion of succession process 46, even if the employer 22 cannot settle the amount entitled by the existing member 32.

The employee 24 may leave the employer 22 voluntarily or by dismissal, known as membership exit 38. According to the human resource management method 20, membership qualification is constantly assessed by the employer 22 in order to determine if the employee 24 still qualifies for the Maturity Amount of Club Reward (MCR). For example, the Maturity Amount of Club Reward (MCR) is confiscated if the member 32 is immediately dismissed 40 if found committing illegal offences, such as theft, bribery, cheating or corruption. Alternatively, the member 32 is transferred 42 to another position with the employer 22, the rate of the Maturity Amount of Club Reward (MCR) is different, having another factor. The total Maturity Amount of Club Reward (MCR) is accumulative, including past roles if the member 32 with the employer 22. Some of these past positions may not qualify for the membership with the alumni club 30 at all (i.e. f=0). In a further alternative, the member 32 leaves employer 22 for a period and rejoins 44 the employer 22 years later as a new employee 24. The rejoining employee 24 has to follow the entire human resource management method 20 again, in order to be qualified for the Maturity Amount of Club Reward (MCR).

In an authorised membership exit 38, the member 32 terminates his employment with the employer 24, and begins his succession process 46. The member 32 is assessed by his employer 22 who monitors information, document and responsibility transfer between the member 32 and his successor with the employer 24. The membership is terminated 48 without any of the Maturity Amount of Club Reward (MCR) if the succession process 46 is not completed perfectly. In contrast, the Maturity Amount of Club Reward (MCR) 50 is automatically remitted to a bank account of the member 32 if the succession process 46 is successfully finished.

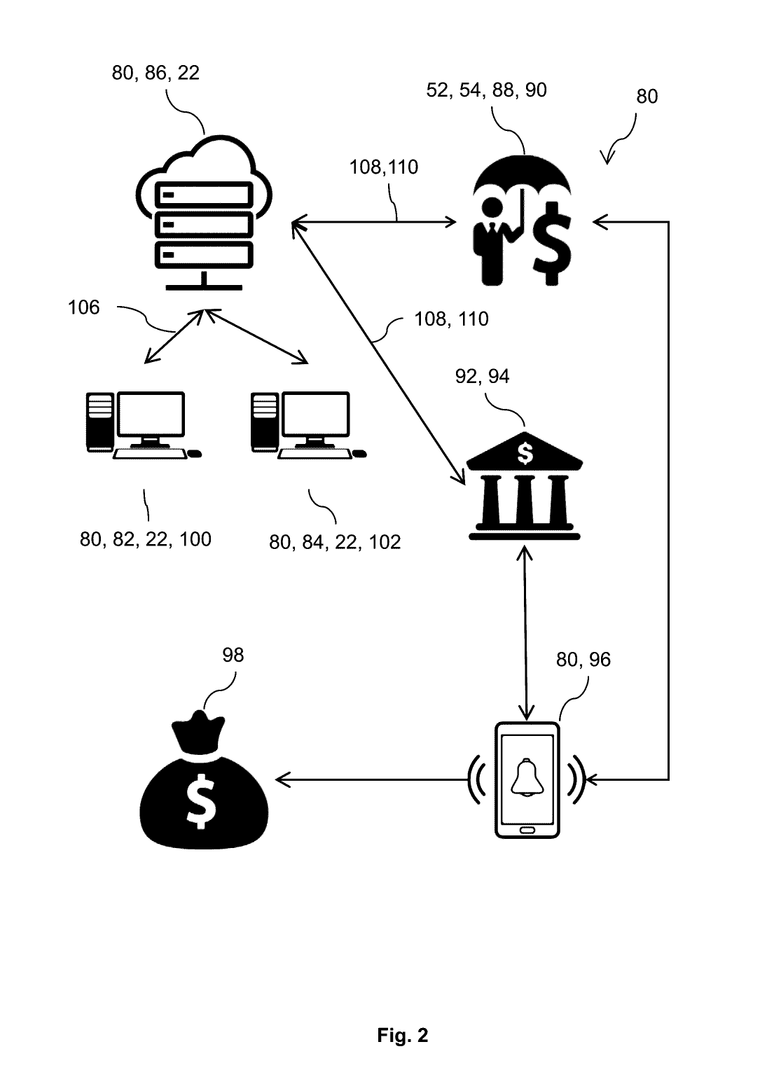

FIG. 2 illustrates implementation of the human resource management method 20. Several electronic devices 80 of multiple parties 24, 30, 32, 90, 94 are involved for implementing the human resource management method 20. The electronic devices 80 include local personal computers 82, 84 of the employer 22, a computing server 86 of the employer 22, a distant computing server 88 of an insurance company 90, a remote computing server 92 of a bank 94, a mobile communication device 96 of the member 32. FIG. 2 further illustrates a fund 98 that is received by the member 32. The human resource management method 20 is executed automatically by computer programs (also known as applications or apps) that are installed on these electronic devices 80 respectively.

According to FIG. 2, the local personal computers 82, 84 consist of a first local personal computer 82 of human resource of the employer 22, which executes the human resource management method 20. For example, an operator 100 of the first local personal computer 82 (known as human resource executive) manages a checklist that enumerates tasks to be completed in order to complete the succession process successfully. The tasks include introducing past customers to successors, returning company manuals to libraries, and handing over company vehicles. The operator of the first local personal computer 82 is able to monitor and determine if the succession process 46 has been duly completed according to standard operating procedures of the employer 22. Following a notice from the human resource executive 100, a manger 102 of the employer 22 conduct documentation review and personal interviews with one or more successors 104 of the exiting member 32 such that succession process 46 is closely monitored. Notes and other inputs of the succession process 46 are further entered by the manager 102 via the second local personal computer 84.

Both the first local personal computer 82 and the second local personal computer 84 are connected to the distant computing server 88 of the employer 22 via a local area network (LAN) 106 (e.g. ethernet). The distant computing server 88 of the employer 22 is further connected to the distant computing server 88 of the insurance company 90 via internet 108. The computing server 86 of the employer 22 is further connected to the remote computing server 92 of the bank 94 via the internet 108. Both these computing servers 88, 92 are remotely connected to the mobile communication device 96 (e.g. mobile phone, tablet and personal computer) of the member 32 via a telecommunication network 110 (e.g. 4G as the fourth generation of mobile telecommunication).

Once authorised by the two human resource executive 100 and the manager 102 in charge of the succession process 46, the computing server 86 of the employer 22 provides electronic instruction to both the distant computing server 88 of the insurance company 90 and the remote computing server 92 of the bank 94 via the internet 108. In turn, the distant computing server 88 of the insurance company 90 and the remote computing server 92 of the bank 94 additionally connect and converse with the mobile communication device 96 respectively. Particularly, since each of the electronic devices 80 have their unique multiple electronic identities, the distant computing server 88 of the insurance company 90 and the remote computing server 92 of the bank 94 are able to verify identification and authenticities of these electronic devices 80. For example, the mobile communication device 96 has a media access control address (MAC address) and an International Mobile Station Equipment Identity (IMEI) that unique identifies the mobile communication device 96. The distant computing server 88 of the insurance company 90 and the remote computing server 92 of the bank 94 are further capable of sending a one-time password (OTP) that is valid for only one login session or transaction, for authorised communication between mobile communication device 96 and the two computing servers 88, 92 respectively. Hence, electronic identities and authorisations are statically or dynamically verified between the employer 22, the financial institutions 90, 94 and the member 32. After proper authorisation, the distant computing server 88 of the insurance company 90 and the remote computing server 92 of the bank 94 transfer fund 98 to relevant bank account(s) of the member 32, till depletion of the membership reward 50 according to predetermined schedules automatically.

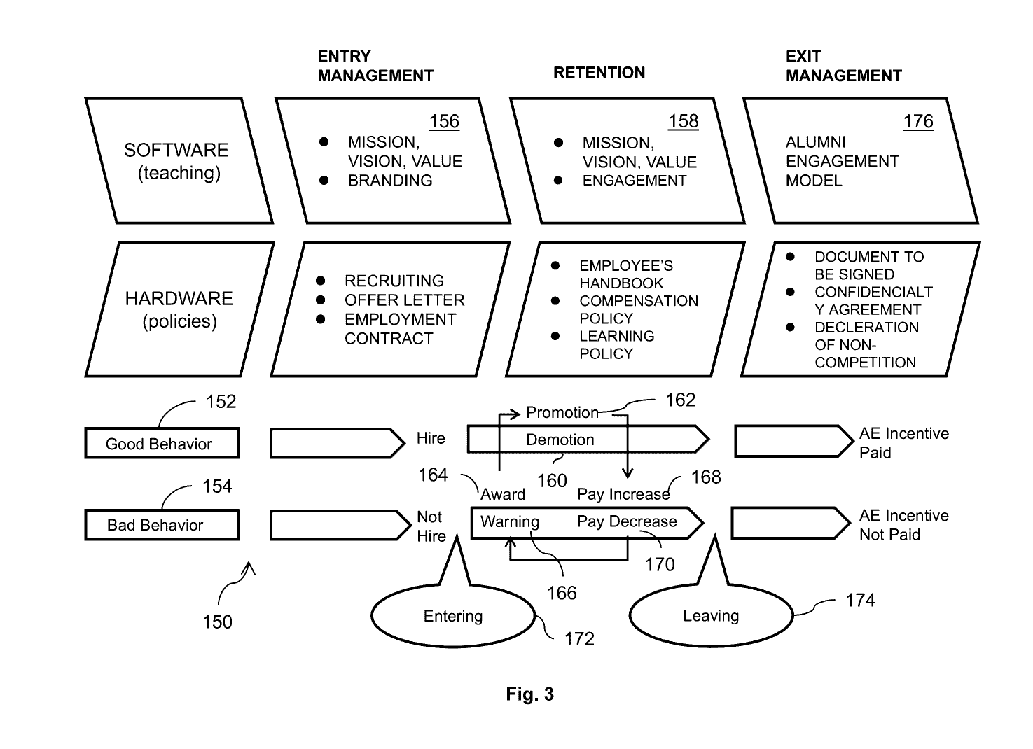

FIG. 3 illustrates an employee engagement model 150 that incorporates the human resource management method 20. The human resource management method 20 is alternatively known as an alumni engagement model 20 because qualified employees 24 are engaged as members 32 of the alumni club 30.

According to the employee engagement model 150, candidates are invited to apply to be employees 24 of the employer 22. Candidates who possess necessary qualifications, skills, health conditions and positive attitudes are engaged as employees 24. For example, candidates with good aptitude are hired by the employer 22, whilst candidates with unsuitable aptitude are rejected (i.e. not hired). When initially employed, the employees 24 are trained with corporate mission, vision, value and branding of the employer 22, which is known as entry management 156. The entry management 156 further includes recruiting exercise, receiving offer letters from the employer 22 and signing of employment contracts.

During employment, the employees 24 enter retention schemes 158 of the employer 22. The retention schemes 158 provide regular and continuous programmes on corporate mission, vision, value and professional engagement trainings to the employees 24. For example, the employees 24 receive employee's handbook, compensation policies and learning policies of the employer 22. Particularly, employees 24 who have met the criteria 28 and satisfy the membership qualification are accepted as members 32 of the alumni club 30. During entire period of employment with the employer 22, an employee 24 may receive demotion 160 if perform badly, or promotion 162 if achieve excellence. The employee 24 may further receive award (e.g. trophy or cash) 164 when accomplishing goals of the employer 22, or get warning 166 if causing damages to the employer 22. Additionally, either as an employee 22 or a member 32 of the alumni club 30, a person 22, 32 is encouraged with salary increase and/or career advancement 168 if performing well consistently. Contrarily, the person 22, 32 gets salary decrease 170 if working continuously below expectation over a 3-year period. In the retention schemes, the person 24, 32 who enters 172 the retention schemes 158 is subjected to regulations of the retention schemes 158. However, the person 24, 32 who leaves 174 the retention schemes 158 may qualify none or some of the retention schemes 158. For example, the member 32 who resigns and completes the succession process 46 well is entitled with the membership reward 50.

Exit management schemes 176 applies to both employees 24 and members 32. However, only members 32 of the alumni club 30 are subjected to the human resource management method 20 by the employer 22. All people 24, 32 who leave the employer 22 are required to the exit management schemes 176, which include handing over relevant properties of the employer 22, signing confidentiality agreements and giving non-competition declarations. Referring also to FIG. 2, the membership reward 50 (also known as AE incentive) is delivered to an exit member 32 after successful completion of the succession process 46. To the contrary, the membership reward 50 is not paid to an exit member 32 if the succession process 46 is not properly completed. Whether the succession process 46 is well finished is determined by the employer 22, typically after one year from the date of membership exit 38.

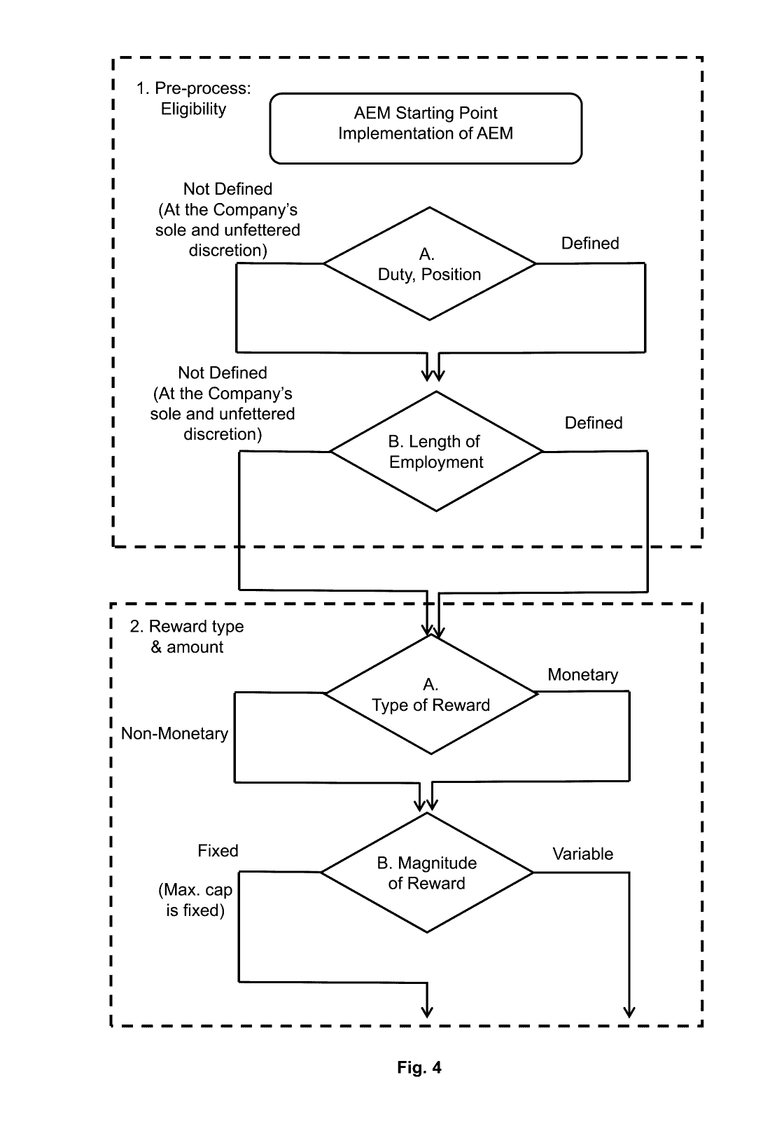

FIGS. 4 to 12 provide another embodiment of the invention. The embodiment comprises parts or method steps that are similar or identical those of the earlier embodiment. Relevant description of the similar or identical parts or steps is hereby incorporated by reference.

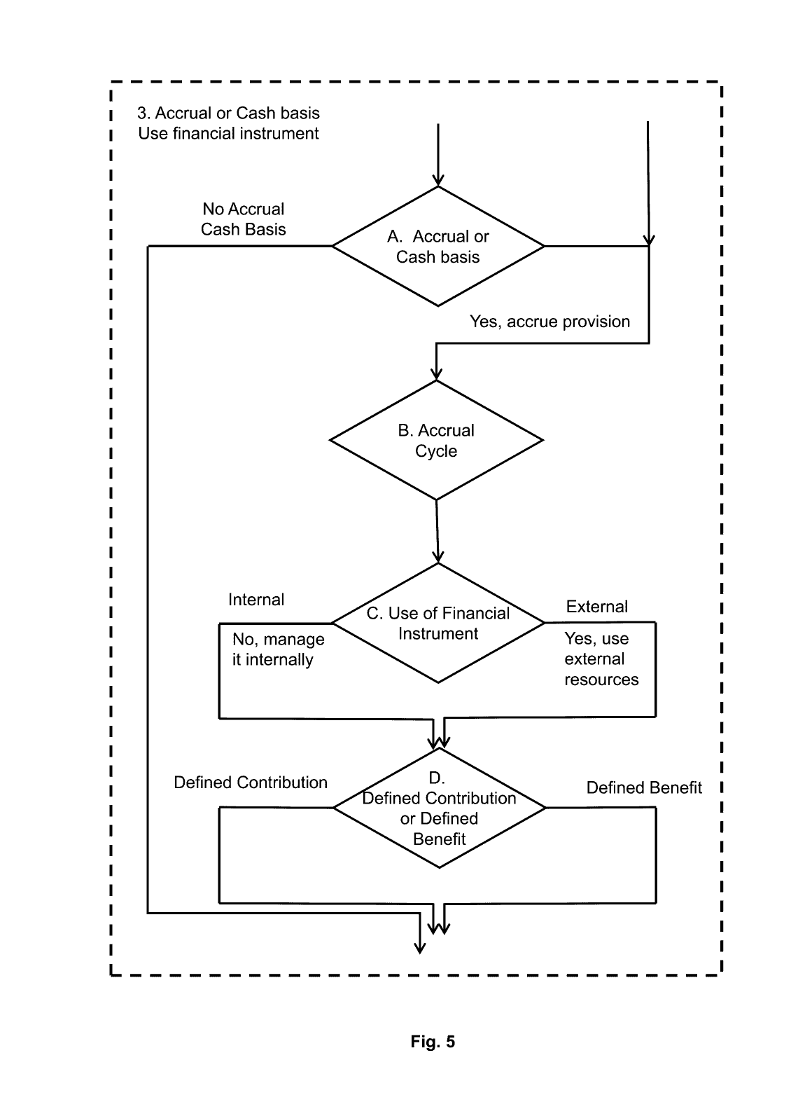

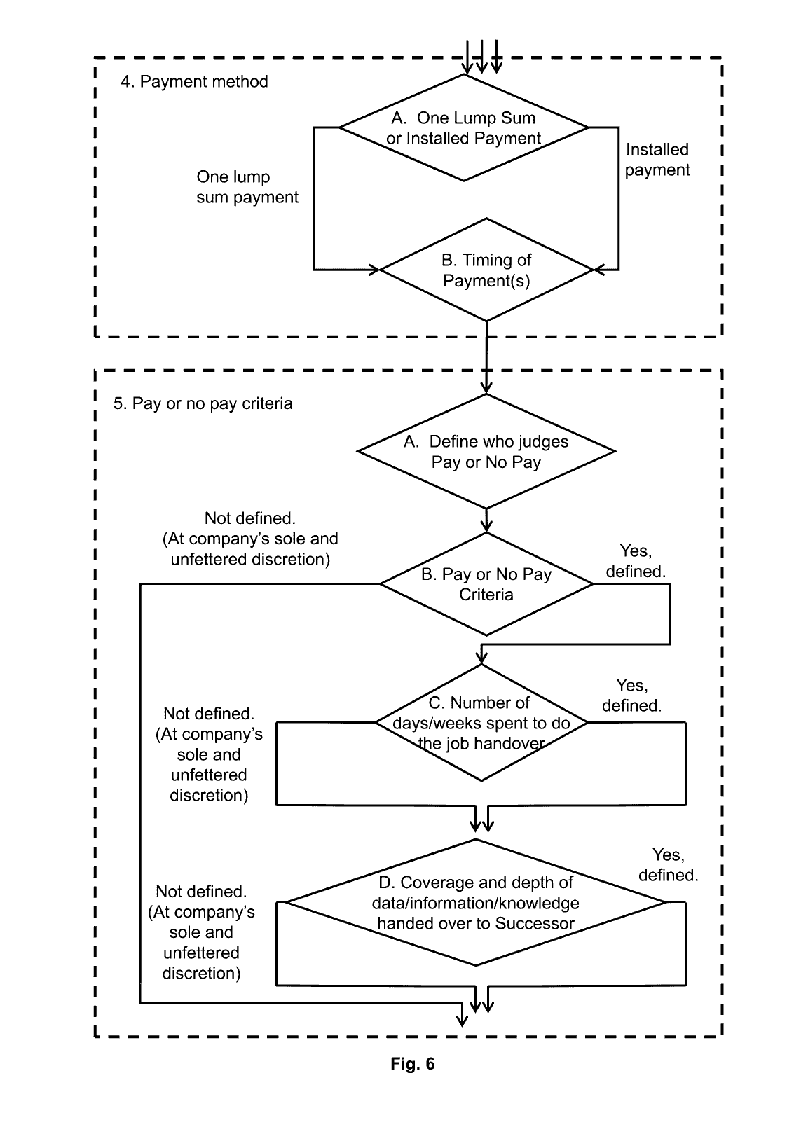

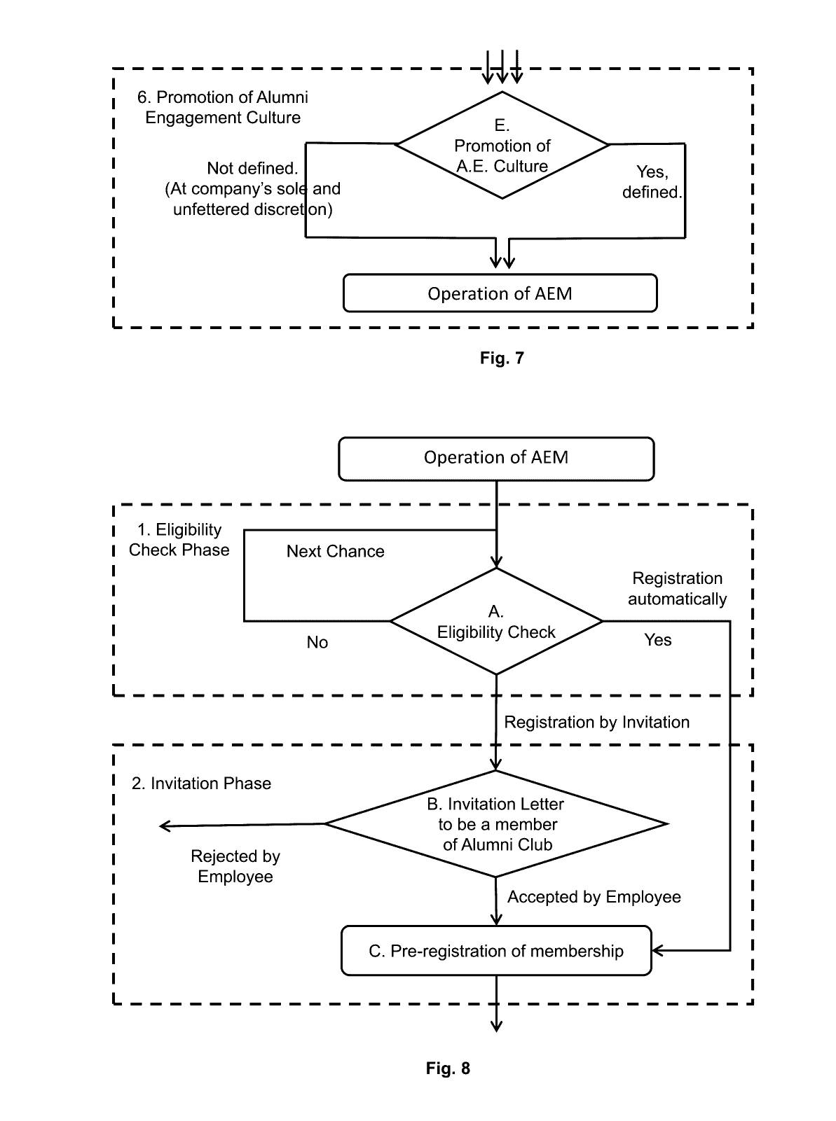

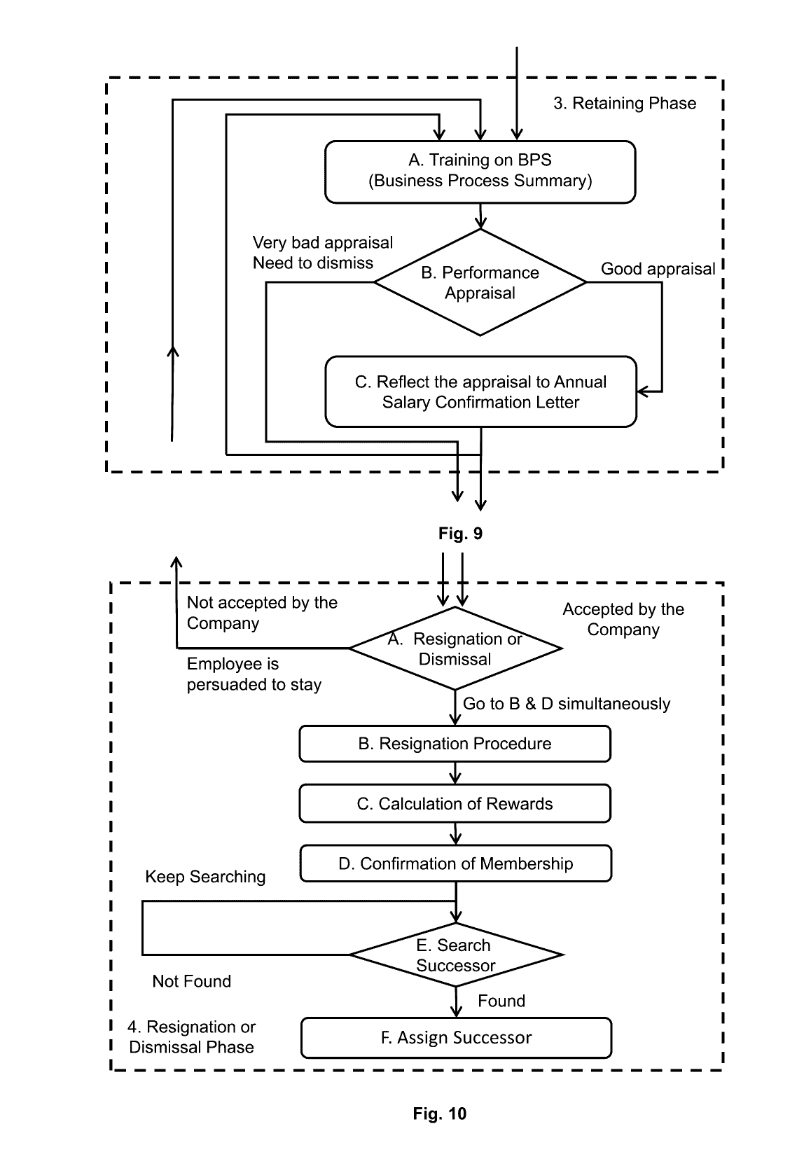

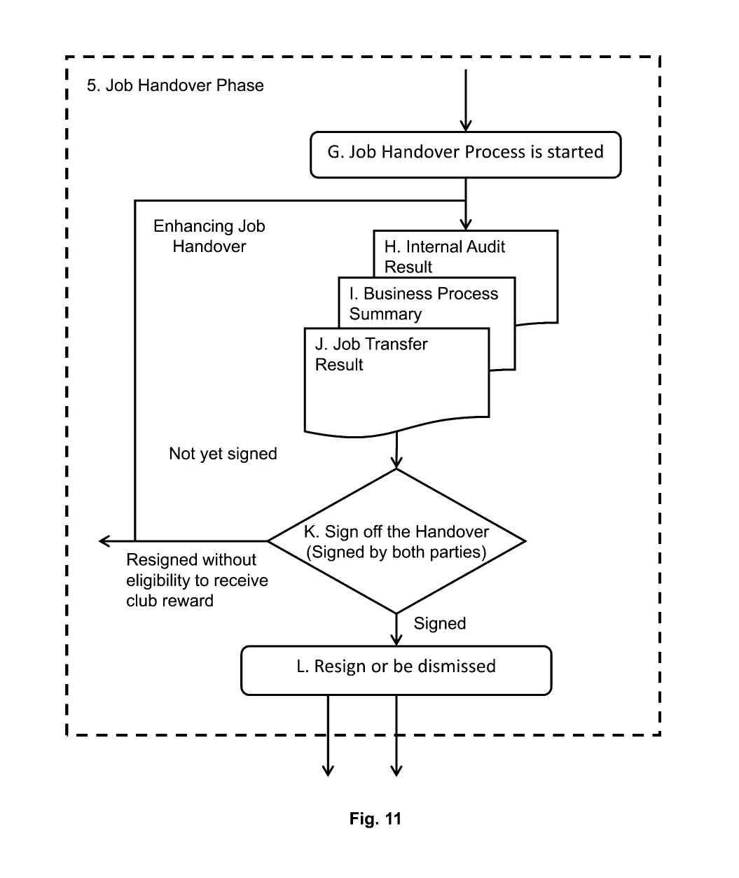

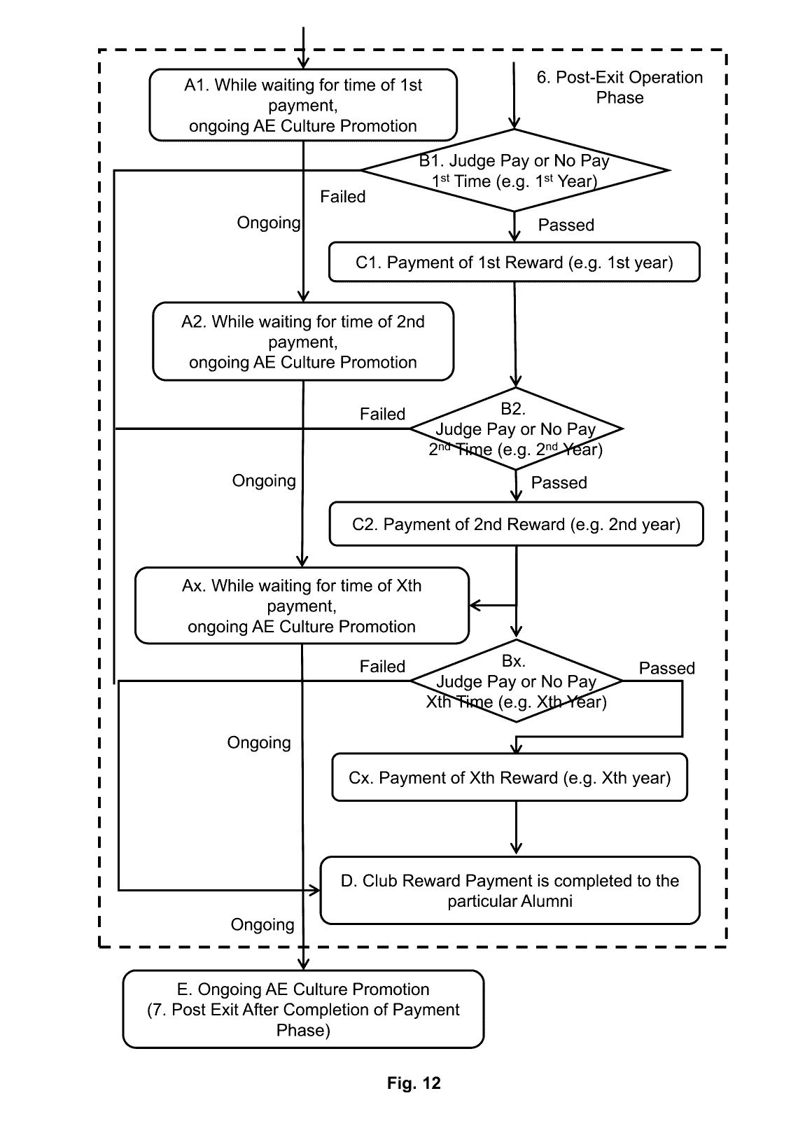

Particularly, FIG. 4 illustrates a pre-process of an AEM chart, which comprises a first stage on eligibility and a second stage on reward type with amount indicated. FIG. 5 illustrates the pre-process that comprises a third stage of accrual or cash basis by using financial instrument. FIG. 6 illustrates a post-process of the AEM chart, which comprises a fourth stage of payment method and a fifth stage of pay or no pay criteria. FIG. 7 illustrates the post-process of the AEM chart, which comprise a sixth stage of promotion of alumni engagement culture. FIG. 8 illustrates an operation diagram of AEM method having a first stage known as eligibility check phase and a second stage of invitation phase. FIG. 9 illustrates the operation diagram of the AEM method having a third stage of resignation phase. FIG. 10 illustrates the operation diagram of the AEM method having a fourth stage of resignation or dismissal phase. FIG. 11 illustrates the operation diagram of the AEM method having a fifth stage of job handover phase. FIG. 12 illustrates the operation diagram of the AEM method having a sixth stage of operation phase and a seventh stage of post-exit phase.

Referring to FIGS. 4 to 12, the Alumni Engagement Model (AEM) is a simple Human Resource Management model to prevent these typical problems that an employee may cause when he or she decides to leave the company. Particularly, at time of recruiting a new employee, such as an officer or director, a company (employer) puts up in writing a list of potential risks which the company do not want to see them happening, and share the list with the respective new employee, officer or director. When it actually comes to the time when the employee, officer or director, really leaves the company, the company make a lump sum of incentive payment after a period of time (e.g. one year later) to the former employee if the leaving employee has not caused any problem given in the list.

The Alumni Engagement Model is not a retention plan. There are many good retention practices, however, they are aiming to prolong period of time of employment by motivating and incentivizing employees. The company may conduct all kinds of retention practices, too. Instead, the AEM model is based upon an assumption that certain probability of job hopping do take place in spite of retention. The AEM is not a measure to reduce job hopping, but is a measure to reduce typical problems that often arise when the job hopping happens.

The main objective of the Alumni Engagement Model is to reduce or eliminate Practical Human Resource Risks. Such Practical Human Resource Risks may occur at any time. However, these risks may occur more often during the exit management phase of HR (human resource) management as compared to the other two phases among the three phases of HR management according to FIG. 2 from 1) Entry, 2) Retention and 3) Exit phases. Following four (04) types of problems are covered by the Alumni Engagement Model.

### 1 Interruption of, or Degradation to Quality of Business Operation Caused by Improper Job Handover of a Leaving Employee

Once an employee receives a better offer from a new company, the employee tends to forget responsibility with the existing employer, which often causes inferior handover of the departing employee's job to a successor. Very frequently, the successor cannot be recruited in time to give even a chance to obtain job handover from the leaving employee. The AEM is a technique to incentivize and remind the departing employee of proper job handover by reward and by culture of alumni engagement.

2. Former Employee Working for Competitors and/or Misusing Trade Secrets or Confidential Information.

In many cases, employees are asked to sign a memorandum to pledge that the employees shall not work for a competitor until certain number of years are past from resignation. Experience often tells that a signed piece of paper is not sufficient and does not provide much protection to the company (employer). Besides, the employer's ability to regulate the departing employee's freedom of job taking by contract is limited.

Instead, the AEM is an initiative to discourage the departing employee from working for competitors.

Misappropriation of trade secrets or confidential information is protected with good governance and internal controls in place. Incentivizing the departing employees by the AEM would be an additional measure. The company or employer reserves the right to define “competitors” and “misappropriation” of trade secrets and confidential information.

3. Blemish to Reputation and/or Damage to Trust Between the Company and its Stakeholders, Including Customers, Suppliers and Other Employees, Caused by Leaving Employee.

In order for the former/departing employee to receive the Alumni Club Incentive, the departing employee is not allowed to spread negative news of the employer, and to harm trust between the company and its stakeholders, including customers, suppliers and other employees.

Again, the risk of corporate reputation derogation associated with leaving employees is prevented by ongoing good engagement culture promoted throughout the company. Some managers of the company are good to manage his/her organization's culture, whilst other managers are not good at such skills. The AEM gives a complementary measure to incentivize positive behaviours of leaving employees. The AEM provide a system that encourages integrity of employees without overly depending individual leaders' skill or capabilities.

### 4. Damage or Degradation to Quality of Business Operation Caused by Fraud or Gross Negligence Committed by Leaving Employee

In many cases, such fraud or gross negligence is found only after a period of time after the employee's resignation. By that time, usually, the resigned employee has already received all of the salary, bonus and benefits. It is also not practical to retrieve previously paid remunerations from the resigned employee. The AEM allows the employer not to pay the Alumni Club Incentive after discovery of such fraud or gross negligence. Moreover, the Alumni Club Incentive gives additional motivation, during employee's service, to be more careful about of committing fraud and negligence.

Corresponding to FIGS. 4 to 12, the AEM Flow Chart explains how the AEM is implemented.

### Implementation of AEM

### Pre-Process

1. Define Eligibility
   (A) Define by Duty/Position Defined or Not defined
   (B) Define by Length of employment Defined or Not defined
2. Define Reward type & amount
   (A) Define Type of Reward Monetary Non-monetary
   (B) Define Magnitude of Reward
3. Accrual or Cash basis
   Use or Not Use of Financial Instruments
      (A) Decide Accrual or Not Accrual basis Cash basis
      (B) Decide Accrual Cycle Month, Quarter, Year, etc.
      (C) Decide Use of Financial Instruments Bank, Fund, Insurance, etc.
      (D) Defined Contribution or Defined Benefit

### Post-Process

4. Define Payment Method
   (A) One Lump Sum or Installed Payment
   (B) Define Timing of Payment(s)
5. Define Pay or No Pay Criteria
   (A) Define the person in charge of final judgement
   (B) Define Pay or No Pay Criteria
   (C) Define Quantitative Criteria such as Number of days/weeks spent to do the job handover
   (D) Define Qualitative Criteria such as Coverage and depth of data/information/knowledge to be handed over to Successor
6. Promotion of Alumni Engagement Culture
   (E) Define methodology of AE Culture Promotion

### Operation of AEM

### Entry Operation

1. Eligibility Check Phase
   (A) Eligibility Check
2. Invitation Phase
   (B) Invitation Letter to Alumni Club
   (C) Pre-registration of membership

### Retaining Operation

3. Retaining Phase
   (A) Training of BPS (Business Process Summary)
   (B) Performance Appraisal
   (C) Reflect the appraisal to Annual Salary Confirmation Letter

### Pre-Exit Operation

4. Resignation/Dismissal Phase
   (A) Resignation or Dismissal Accept or Persuasion
   (B) Resignation Procedure
   (C) Calculation of Rewards
   (D) Confirmation of membership
   (E) Search Successor
   (F) Assign Successor
5. Job Handover Phase
   (G) Job Handover is started.
   (H) Internal Audit Result
   (I) BPS Business Process Summary
   (J) Job Handover Result
   (K) Sign Off of Job Handover
      Signed by both leaving employee and successor
   (L) Resign or be dismissed

### Post-Exit Operation

7. Post Exit before completion of reward payment
   (A1) AE Culture Promotion
   (B1) Judge Pay or No Pay 1st time
   (C1) Payment 1st time
      (A2) AE Culture Promotion
      (B2) Judge Pay or No Pay 2nd time
      (C2) Payment 2nd time
      (Ax) AE Culture Promotion
      (Bx) Judge Pay or No Pay Xth time
      (Cx) Payment Xth time
      (D) Reward payment is completed
8. Post Exit after completion of reward payment
   (E) AE Culture Promotion continues
1. Implementation of the AEM comprises pre-processes and post-processes. Pre-processes comprises a first step of defining “Eligibility” which further comprises various steps such as definition of duty/position and definition of length of employment.

There are mainly two ways to make decision. The first is to define eligibility of employees, officers or directors who are invited for pre-registration of the membership of the AEM. The second is to offer pre-registration at the company's sole and unfettered discretion.

The following are some of typical examples of “eligibility”:
a) All employees, officers or directors are invited for pre-registration of the membership of AEM upon starting the position at the company;
b) All employees, officers or directors are invited for pre-registration of the membership of AEM after X years of service with the company;
c) All employees are put to the candidate of AEM upon being promoted to a manager or a higher position than manager.

The typical example of offering pre-registration at the company's sole and unfettered discretion is by nomination of CEO (Chief Executive Officer) and by approval from the Board of Directors Meeting.
2. A second step of decision making is definition of type of reward and magnitude of reward.

Type of reward contains monetary reward, non-monetary reward, and combination of two or more kinds of rewards.

The monetary reward includes cash or cash-equivalence reward, such as stock, security, insurance. The non-monetary reward includes a club membership, corporate benefit reward (e.g. free accommodation), or any other tangible or intangible reward (e.g. medal of long-service, honorary position in an organization).

There are a few factors to determine the type and magnitude of reward. The following are two examples, which include:
a) whether it is influential enough to incentivize an employee to refrain from committing practical human resource risks mentioned earlier.
b) whether it is a reasonable amount to bear for the employer in terms of financial performance of the company.

There are various ways to calculate the amount of reward. A typical example is to calculate the reward by multiple of the latest month's salary, such as 10 times the last month's salary.
3. A third step of decision making is a method of accumulation of the reward or accrual of it. The method contains a few factors such as following.
   a) The first decision is whether accrual is necessary or not. If the employer chose not to bother with the accrual monthly, quarterly or annually, then there will be no expense shown in the company's income statement until the time when the employee leaves. The whole amount of his/her reward will impact to the income statement of the month, quarter or year of his/her departure. Proper accounting transaction is practiced by one or more professional accountants or tax advisors.
   b) If the company decide to do the accrual, the second decision to make is to choose how to accumulate the accrual. There are mainly two ways to accumulate. One is to set aside the accrual internally within the company's custody. The other is to use an external resource such as a bank or an insurance company.
      Typical example of using an external resource is to pay out the accrued amount to buy an investment-related insurance policy or other financial instruments.
   c) Another decision to make may be which ways to elect between the contribution or the benefit.
4. A forth step of decision is to define a payment method. There are a few factors to consider the payment method. One is to decide whether to pay the reward in one lump sum or by installment.

Timing of the lump sum payment or installment is to be considered further. There are mainly two ways to structure the payment timing.
a) One is to pay out the reward in one lamp sum after a reasonable period of time.
b) The other is to pay out the reward by multiple times of installment. For example, a first installment payment at 50% of the total amount is made after one year since departure date of the employee; a second installment of 25% of the total amount is made after the second year; and the remaining 25% of the total amount is made after the third year. To pay the reward in one lump sum, the total amount is dispatched one year after the termination of employment contract.

If the reward is paid immediately after the employee departure, the employer unusually does not have sufficient time to judge whether all Practical Human Resource Risks are avoided or reduced.
5. A fifth step of decision making is to define criteria for Pay or No Pay. There are a few steps to structure the relevant criteria.
   1) Define who decides on Pay or No Pay of the reward
      Typical examples are by CEO and by an alumni club committee meeting.
   2) Define the relevant Pay or No Pay criteria
      Although it is possible not to define the criteria, the company makes policy that the company has the sole and unfettered discretion. The company alternatively sets certain parameters on how the decision is made.
   For example, the following are typical examples of the parameters.
   a) Firstly, the company sets quantitative parameters, such as number of days/weeks necessary for the leaving employee to spend to do the job handover with the successor (Required Handover Period). The company defines when to start counting the length of time.

Typically, the Required Handover Period is not started from the date of Letter of Resignation because the company does not have sufficient to uncover potential fraud and assign a successor. Instead, the length of time is counted from the date the company's identification and assignment the successor.

The company sets different the length depending on seniority levels of different jobs. For example, two weeks are given for staff level; four weeks appointed to PME (Professionals, Managers, Executives), twelve weeks designated for high management; and twenty-four weeks prescribed to management officer/director level.

Required Handover Period is defined in a salary confirmation letter issued every time when the employee's salary or position of job is promoted/demoted.

The Required Handover Period is clearly defined in the AEM contract between the employer and the employee so that the Required Handover Period is legally distinguished from the severance pay period as in a relevant jurisdiction (e.g. Singapore), which is customary to request an employee go without reasons by paying thirty days of severance.
b) Secondly the company sets qualitative criteria. Qualitative criteria are quality of job handover such as coverage and depth of data/information/knowledge that are required to be handed over to the successor.
   Among many, three examples of qualitative criteria are listed below.
   (i) The job handover process requires the confirmed alumni to take an internal audit prior to leaving;
   (ii) The job handover process requires the employee to record the Business Process Summary which describes important data, information and knowledge necessary for the successor to carry on the job; and
   (iii) The job handover process requires the successor to appraise satisfaction level of the job handover and sign off the Business Process Summary.

Typically, the company demands Business Process Summary digitally or via a hard copy, which describes important matters the successor on performing the job. The company further specifies detailed content of the document. For example, the company stipulates that the document must contain list of customers with names/contacts of key persons.

Referring again to FIGS. 4 to 7, at the first stage of eligibility during the pre-process, the AEM has following steps to conduct the eligibility by:
1. defining everyone is applicable;
2. describing nature of duties;
3. clarifying hierarchy of position, such as officers, directors, non-employees, contractors, consultants.

After probation period and the relevant personnel is confirmed, on the Xth (X denotes a natural number) year and after completing multiple different assignments, the relevant personnel are deemed as accepted by the AEM.

At the second stage of Reward and payment, there are two typical factors to consider:
1) if the amount and mode of reward is sufficient to discourage the departing employee from committing the four kinds of human resource risks; and
2) if the amount is a reasonable and justifiable to the company in terms of financial liability.

Monetary reward of the AEM includes cash, stock, fund and insurance.

At a third stage of accrual or cash basis, and use of financial instruments, if an eligible employee chooses not to bother with the accrual monthly, quarterly or annually, there will be no expense shown in the company's income statement if the employee leaves.

The whole amount of his reward will impact income statement of the month, quarter or year of the incident. Proper accounting transaction should be consulted with one or more professional accountants or tax advisors. When considering defined contribution or defined benefit (step D of the third stage of accrual or cash basis), typically, the defined contribution is not recommended because it can give false impression that the beneficiary (leaving employee) deserves to control the reward.

In the pros-process when deciding the timing of payment, a typical example is to pay the reward one year after the termination of employment contract. Usually a payment earlier than one year may have less effect of restraint to the HR-related risks. For example, a 3-year payment scheme is distributed by three times of payment at 50%, 20% and 25% of the total amount. A 5-year payment scheme is distributed as 20% of the total amount yearly till the fifth year. A 10-year payment scheme is distributed as 10% for every year till the fifth year. There may be a life-time annuity too.

At the fifth stage on pay or no pay criteria, a managing director, a board of directors or an appointed committee have the authority to decide. At step C, when deciding the number of days/weeks to perform the job handover, a junior staff is assigned with two weeks; a manager is assigned with one month; an officer is assigned with three months; and a director is assigned with six months. At step D on deciding the coverage or depth of information transferred to a successor, the company defines needed information to be transferred according to internal documents; hears opinions from the successor as reference, and conduct internal audit before the employee's departure.

At the sixth stage of promotion of alumni engagement culture, examples of promotion include alumni bulletin, periodical meetings and special company events.

Referring again to FIGS. 8 to 12, at first the eligibility check phase, the AEM requires Eligibility Check in accordance with the parameters set at Pre-process implementation, such as Duty, Position and Length of employment. At the second invitation phase, those eligible employees (and officers and/or directors) are pre-registered to the membership either automatically or by invitation. Typically, by giving option to employees (officers/directors) an option to reject invitation, those who accept would have better understanding that the reward might not be grant subject to the company's decision on its sole discretion. At the third retaining phase, the Retaining Operation is an ordinary HR operation which is not unique to AEM. It is to train, motivate and lead employees. It typically includes various training programs, performance appraisals and feedback communications, sometimes 360 degrees (i.e. all-rounded). It is not unique with AEM to conduct an annual appraisal. It is a typical HR operation to document the increase or decrease in salary, and promotion or demotion of assignment. Typically, it is documented at the beginning of Financial Year, in an Annual Salary Confirmation Letter. In order to reflect the appraisal to annual salary, there are unique enhancements from ARM's perspective to the retaining operation.
1) Among various trainings, it is preferable to specially train how to write BPS (Business Process Summary) which is a document required to write by all employees for their any types of jobs. BPS will be an important parameter for judging grant of the reward, too.
2) As a part of Pay-No-Pay Criteria, the number of days/weeks required for the Job Handover (after the successor is assigned) should be also documented as and when promotion/demotion of his/her job assignment takes place. It is recommended to be documented in the Annual Salary Confirmation Letter.

At the fourth resignation or dismissal phase, it is up to the company to give or not to give eligibility of Alumni Club Reward to those employees who are dismissed. It is sometimes worth considering to give eligibility because those dismissed employees have more tendency to lack proper Job Handovers and to cause other problems during and after the dismissal. Members of the Club receives membership rules and membership cards.

At the fifth job handover phase, one of the key successful factors of AEM is to start counting the days/weeks to share with the successor for the Job Handover from the day when the successor is assigned. It is not counted from the day of turning his letter of resignation.

To enhance job handover, the following are typical qualitative criteria that are preferable to be set as a Pay-No-Pay criterion.
1) Conduct Internal Audit before departure of an employee
   Therefore, the Internal Audit Report will be on of materials to judge quality of Job Handover.
2) BPS (business process summary)
3) hear from the successor on sufficiency of Job Handover.

Typically, it is beneficial to make both the leaving employee and the successor to sign off the BPS as an indication that the Job Handover is completed. If the successor is not satisfied, the leaving employee needs to make effort to complete the Job Handover for getting official signing off. Getting the official signing off does not automatically mean that the leaving employee will definitely receive the reward. However, no signing off before leaving the company automatically means that the departing employee is not eligible for the reward.

During the post-exit operation before completing payment, the Promotion of Alumni Engagement Culture is conducted typically with such arrangements like issuing Alumni Bulletin periodically, facilitating meetings and events periodically and facilitating some kind of SNS. When judging whether to pay the first time of the reward, among many issues to judge, there are following four main decisions to make.
1) whether his job handover was satisfactory and has not caused interruption or degradation of business operation.
2) whether the departing employee has not worked for competitors and/or misused trade secrets or confidential information.
3) whether the departing employee has not disparaged reputation of the company or trust between the company and its stakeholders, and
4) whether the departing employee has not committed fraud or gross mistake during time his employment period.

Subsequently, if the payment of Reward is decided to be made in one lump sum, no further decision is necessary. If the payment of Reward is made by installed payments, the company needs to evaluate the four main points above. If the company detects any issues even after the previous payments are effected, future reward payments will be cancelled.

Some or all of the method steps according to FIGS. 4 to 12 are able to be defined by algorithm and programmed. Hence, the AEM is operable by one or more computers to execute the relevant algorithm or programs. For example, relevant computer programs are installed onto non-volatile memory of these one or more computers via networks. Hence, the AEM is able to be efficiently, accurately, securely and easily operated automatically.

In the application, following terms are defined as:
1. MCR Maturity Amount of Club Reward
2. LT Lead Time to the MCR;
3. CED Club Entry Date;
4. CMD Calculation Maturity Date;
5. ACA Annual Contribution Amount;
6. PTP Post Termination Period;
7. BPS Business Process Summary;
8. RC Reward Club.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

20 human resource management method
22 employer
24 employee(s)
26 management staffs
28 criteria
30 alumni club
32 member(s)
34 check membership qualification
36 monetary reward
38 membership exit
40 immediate dismissal
42 membership transfer
44 re-join employment
46 succession process
48 membership termination
50 membership reward
52 insurance company
54 insurance policy
80 electronic devices
82 first local personal computer
84 second local personal computer
86 computing server of the employer
88 distant computing server of an insurance company
90 insurance company
92 remote computing server of a bank
94 bank
96 mobile communication device
98 fund
100 human resource executive
102 manager
106 local area network
108 internet
110 telecommunication network
150 engagement model
152 good behaviour
154 bad behaviour
156 entry management
158 retention schemes
160 demotion
162 promotion
164 award
166 warning
168 pay increase
170 pay decrease
172 enter
174 leave
176 exit management

1. A computer-implemented method of human resource management for completing succession process, the method comprising:
i. deciding, using a computing apparatus to check, if an employee meet criteria of becoming a member of a reward alumni club;
ii. registering the employee as a member with the reward alumni club if the criteria are met;
iii. accumulating membership reward of the member;
iv. checking if the member leaves the reward alumni club;
v. examining, after departure of the member, if succession process of the member has been duly completed;
vi. summarising the membership reward after completion of the succession process; and
vii. disbursing the membership reward to the member.

2. The method as claimed in claim 1 further comprising
checking if the member changes his reward grade with the reward alumni club.

3. The method as claimed in claim 1 further comprising
constraining the membership reward to be within a predetermined limit.

4. The method as claimed in claim 1 further comprising
inviting an employee to join the reward alumni club.

5. The method as claimed in claim 1, wherein
the accumulating membership reward includes:
(i) calculating days of being the member with the reward alumni club;
(ii) counting the total number of days over a ten-year period starting from the date becoming the member;
(iii) deciding a ratio of the days of being the member over the total number of days over the ten-year period;
(iv) accumulating ten times of the latest salary of the member when leaving the employer as the predetermined limit;
(v) multiplying the ratio and the predetermined limit as a final membership reward.

6. The method as claimed in claim 1, wherein
the accumulating membership reward includes:
(i) numbering years of being the member with the reward alumni club;
(ii) getting a year ratio of the number of years being the member over a ten-year period;
(iii) figuring days of the last year of being the member with the reward alumni club;
(iv) obtaining a day ratio of the number of days being the member during the last year;
(v) aggregating ten times of the latest salary of the member when leaving the employer as the maximum membership reward;
(vi) recording a year membership reward by multiplying the year ratio with the maximum membership reward;
(vii) noting a day membership reward by multiplying the day ratio with a last month salary;
(viii) adding the year membership reward and the day membership reward together as a final membership reward.

7. The method as claimed in claim 1 further comprising:
checking at least one electronic address of an electronic device of the employee.

8. The method as claimed in claim 7 further comprising:
updating the at least one electronic address of the electronic device of the employee.

9. The method as claimed in claim 1 further comprising
adopting relevant latest salary of the member for accumulating the maximum membership reward.

10. A system for operating the human resource management method, the system comprising:
a processor operable to decide if an employee meet criteria of becoming a member of a reward alumni club;
wherein the processor is further configured to
i. register the employee as a member with the reward alumni club if the criteria are met;
ii. accumulate membership reward of the member;
iii. check if the member leaves the reward alumni club;
iv. examine, after departure of the member, if succession process of the member has been duly completed;
v. summarise the membership reward after completion of the succession process; and
vi. disburse the membership reward to the member.

11. The system as claimed in claim 10, wherein
the processor is further configured to check if the member changes his reward grade with the reward alumni club.

12. The system as claimed in claim 10, wherein
the processor is further configured to restrict the membership reward to a predetermined limit.

13. The system as claimed in claim 10, wherein
the processor is further configured to invite an employee to join the reward alumni club.

14. The system as claimed in claim 10, wherein
the processor is configured to accumulate the membership reward by:
(i) calculating days of being the member with the reward alumni club;
(ii) counting the total number of days over a ten-year period starting from the date becoming the member;
(iii) deciding a ratio of the days of being the member over the total number of days over the ten-year period;
(iv) accumulating ten times of the latest salary of the member when leaving the employer as the predetermined limit; and
(v) multiplying the ratio and the predetermined limit as a final membership reward.

15. The system as claimed in claim 10, wherein
the processor is configured to accumulate the membership reward by:
(i) numbering years of being the member with the reward alumni club;
(ii) getting a year ratio of the number of years being the member over a ten-year period;
(iii) figuring days of the last year of being the member with the reward alumni club;
(iv) obtaining a day ratio of the number of days being the member during the last year;
(v) aggregating ten times of the latest salary of the member when leaving the employer as a maximum membership reward;
(vi) recording a year membership reward by multiplying the year ratio with the maximum membership reward;
(vii) noting a day membership reward by multiplying the day ratio with a last month salary; and
(viii) adding the year membership reward and the day membership reward together as a final membership reward.

16. The system as claimed in claim 10, wherein
the processor is further configured to check at least one electronic address of an electronic device of the employee.

17. The system as claimed in claim 16, wherein
the processor is further configured to update the at least one electronic address of the electronic device of the employee.

18. A non-transient computer readable medium containing program instructions for causing at least one computer to perform the method of human resource management, the method comprising:
i. deciding, using a computing apparatus to check, if an employee meet criteria of becoming a member of a reward alumni club;
ii. registering the employee as a member with the reward alumni club if the criteria are met;
iii. accumulating membership reward of the member;
iv. checking if the member leaves the reward alumni club;
v. examining, after departure of the member, if succession process of the member has been duly completed;
vi. summarising the membership reward after completion of the succession process; and
vii. disbursing the membership reward to the member.

19. The method as claimed in claim 18, wherein the accumulating membership reward includes:
i. calculating days of being the member with the reward alumni club;
ii. counting the total number of days over a ten-year period starting from the date becoming the member;
iii. deciding a ratio of the days of being the member over the total number of days over the ten-year period;
iv. accumulating ten times of the latest salary of the member when leaving the employer as a predetermined limit;
v. multiplying the ratio and the predetermined limit as a final membership reward.

20. The method as claimed in claim 18, wherein the accumulating membership reward includes:
(i) numbering years of being the member with the reward alumni club;
(ii) getting a year ratio of the number of years being the member over a ten-year period;
(iii) figuring days of the last year of being the member with the reward alumni club;
(iv) obtaining a day ratio of the number of days being the member during the last year;
(v) aggregating ten times of the latest salary of the member when leaving the employer as a maximum membership reward;
(vi) recording a year membership reward by multiplying the year ratio with the maximum membership reward;
(vii) noting a day membership reward by multiplying the day ratio with a last month salary;
(viii) adding the year membership reward and the day membership reward together as a final membership reward.
